(19) United States
(12) Patent Application Publication
(10) Pub. No.: US 2026/0161670 A1
(43) Pub. Date: Jun. 11, 2026

(54) INFORMATION PROCESSING APPARATUS, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventor: Tomoyuki TENKAWA, Chiba (JP)

(21) Appl. No.: 19/404,122

(22) Filed: Dec. 1, 2025

(30) Foreign Application Priority Data
Dec. 5, 2024 (JP) 2024-212424

(51) Int. Cl. G06F 16/28

(52) U.S. Cl. CPC G06F 16/288

(57) ABSTRACT

An information processing apparatus comprises an obtainment unit configured to obtain model information that is information about a machine learning model; a reference unit configured to refer to a database indicating relations among a plurality of machine learning models and obtain related model information indicating a machine learning model related to the obtained model information; and a generation unit configured to, based on the related model information, generate display control information for displaying a screen including information of a recommended machine learning model.

### BACKGROUND

### Field of the Technology

The present disclosure relates to an information processing apparatus, an information processing method, and a non-transitory computer-readable storage medium.

### Description of the Related Art

Systems utilizing machine learning model technology are being put into practical use in various fields, and the number of available machine learning models has become very large. Amidst such circumstances, users are finding it difficult to appropriately select machine learning models suited to their desired applications. There is therefore demand for technologies that assist in selecting machine learning models.

For example, Japanese Patent Laid-Open No. 2020-204970 proposes a method for assisting a user with the task of selecting a machine learning model by displaying the output of a plurality of machine learning models and success/failure determination results to the user in a table format.

Additionally, Japanese U.S. Pat. No. 7,281,427 discloses a technique in which information including a result of learning is prepared as a model version on a task-by-task basis.

However, with the technique disclosed in Japanese Patent Laid-Open No. 2020-204970,the output of a plurality of learning models and success/failure determination results are simply displayed in a table format, and there is thus a problem in that it is difficult to select a machine learning model suited to the user's application from among the vast number of publicly available machine learning models. Japanese U.S. Pat. No. 7,281,427 has a similar problem.

### SUMMARY

Accordingly, an object of the present disclosure is to provide a technique that enables a user to easily select a machine learning model suited to their application.

The present disclosure in its aspect provides an information processing apparatus comprising: an obtainment unit configured to obtain model information that is information about a machine learning model; a reference unit configured to refer to a database indicating relations among a plurality of machine learning models and obtain related model information indicating a machine learning model related to the obtained model information; and a generation unit configured to, based on the related model information, generate display control information for displaying a screen including information of a recommended machine learning model.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic diagram illustrating the hardware configuration of a server-side information processing apparatus of an information processing system according to an embodiment.

FIG. 2 is a schematic diagram illustrating the hardware configuration of a client-side information processing apparatus of the information processing system according to the embodiment.

FIG. 3 is a schematic diagram illustrating the overall configuration of the information processing system according to the embodiment.

FIG. 4 is a block diagram illustrating an example of the functional configuration of the information processing system according to a first embodiment.

FIG. 5 is a flowchart illustrating related model recommendation processing for recommending a related machine learning model according to the first embodiment.

FIG. 6A is a schematic diagram illustrating a machine learning model selection display screen referred to when a user changes a machine learning model.

FIG. 6B is a schematic diagram illustrating a display screen including model information of candidate machine learning models.

FIG. 7A illustrates a database including relation information among machine learning models.

FIG. 7B illustrates a database expressing a relation degree among machine learning models.

FIG. 7C illustrates a database based on a parent-child relationship among machine learning models.

FIG. 7D illustrates a database based on a sibling relationship among machine learning models.

FIG. 7E illustrates a database expressing a usage ratio of the same training dataset among machine learning models, from among training datasets used by each model.

FIG. 7F illustrates a database expressing a degree of relation among machine learning models, based on the machine learning models and information set by the model creators, for each of machine learning models.

FIG. 8 is a flowchart illustrating related model determination processing for determining a related model according to the first embodiment.

FIG. 9 is a block diagram illustrating an example of the functional configuration of the information processing system according to a second embodiment.

FIG. 10 is a flowchart illustrating related model recommendation processing for recommending a related machine learning model according to the second embodiment.

FIG. 11A is a flowchart illustrating related model determination processing for determining a related model according to a variation on the second embodiment.

FIG. 11B illustrates a database of average usage periods of machine learning models according to a variation on the second embodiment.

FIG. 11C is a flowchart illustrating related model recommendation processing for recommending a related machine learning model according to a variation on the second embodiment.

FIG. 12 is a block diagram illustrating an example of the functional configuration of the information processing system according to a third embodiment.

FIG. 13 is a flowchart illustrating related model recommendation processing for recommending a related machine learning model according to the third embodiment.

FIG. 14 is a block diagram illustrating an example of the functional configuration of the information processing system according to a fourth embodiment.

FIG. 15A is a flowchart illustrating related model recommendation processing for recommending a client-side related machine learning model according to the fourth embodiment.

FIG. 15B is a flowchart illustrating related model recommendation processing for recommending a virtual server-side related machine learning model according to the fourth embodiment.

FIG. 16A illustrates an example of a display screen displaying an image during image scrolling with the image out of focus.

FIG. 16B illustrates an example of a display screen for inputting a cause of failure after a failure button is pressed.

FIG. 16C illustrates an example of a display screen displaying an image during image scrolling with a different subject in focus.

FIG. 16D illustrates an example of a display screen for inputting a cause of failure after a failure button is pressed.

FIG. 17 is a table of related machine learning models, detection rates and false detection rates, according to the fourth embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

An information processing system (also referred to as a “machine learning model selection support system”) according to embodiments will be described in detail hereinafter. The information processing system according to the embodiments includes a virtual server-side information processing apparatus and one or more client-side information processing apparatuses connected to the virtual server-side information processing apparatus over a network in a communication-enabling manner. Note that the virtual server may be a physical server, a server constituted by one or more computers, or the like.

### Hardware Configuration of Information Processing System

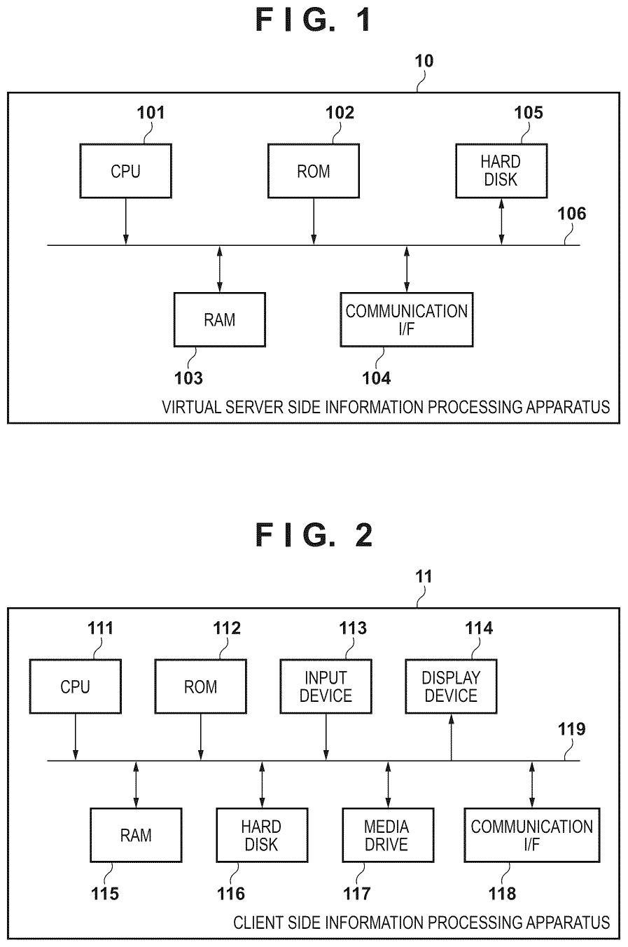

Before describing the present embodiment, the hardware configuration of an information processing apparatus implementing the information processing system described in each embodiment will be described with reference to FIGS. 1 and 2.

### Hardware Configuration of Virtual Server

FIG. 1 is a schematic diagram illustrating the hardware configuration of a virtual server-side information processing apparatus 10 of the information processing system according to an embodiment.

The information processing apparatus 10 may be configured on a cloud server, for example. The information processing apparatus 10 may be a computer or a virtual computer, for example. The information processing apparatus 10 includes a CPU 101, a ROM 102, a RAM 103, a communication I/F 104, a hard disk 105, and a system bus 106. The CPU 101, the ROM 102, the RAM 103, the communication I/F 104, and the hard disk 105 are connected to each other by the system bus 106 so as to be capable of exchanging data with each other.

The CPU 101 is a central processing unit, and is a processor. The CPU 101 controls the information processing apparatus 10 as a whole, for example. The CPU 101 controls various devices connected to the system bus 106, for example. The CPU 101 implements various functions and executes various types of processing by reading out computer programs (also called “programs”) stored in the ROM 102, the hard disk 105, or the like, loading the programs into the RAM 103, and executing the programs.

The information processing apparatus 10 may include, instead of the CPU 101 or in addition to the CPU 101, another processor such as a Micro Processing Unit (MPU), a Graphics Processing Unit (GPU), a Neural Processing Unit (NPU), or a Quantum Processing Unit (QPU). Additionally, the information processing apparatus 10 may have a plurality of processors of the same type, and each processor may implement different functions.

Some or all of the functions of the information processing apparatus 10 may be implemented by one or more circuits, such as an Application Specific Integrated Circuit (ASIC), a Programmable Logic Device (PLD) including a Field Programmable Gate Array (FPGA), or the like.

The ROM 102 is a read-only memory, and is a non-volatile memory. The ROM 102 stores a Basic Input/Output System (BIOS) program and a boot program.

The RAM 103 is a random access memory, and is a memory that can be read and written to at high speed. The RAM 103 is used as a main storage device for the CPU 101, and functions as a working area when executing programs. The RAM 103 stores data such as programs read from the hard disk 105, parameters necessary for executing programs, and the like when executing programs, for example.

The communication I/F 104 is a communication interface that communicates with external apparatuses such as a client-side information processing apparatus 11 (described later) over a network. The communication standard of the communication I/F 104 may be Ethernet (registered trademark), Universal Serial Bus (USB), serial communication, wireless communication, or the like, and may use any type of communication.

The hard disk 105 is a non-volatile storage device. The hard disk 105 is used for storing and loading application programs, data and libraries necessary for executing the programs, data to be processed by the programs, and the like. Instead of the hard disk 105 or in addition to the hard disk 105, the information processing apparatus 10 may include another storage device such as a Solid State Drive (SSD).

### Hardware Configuration of Client

FIG. 2 is a schematic diagram illustrating the hardware configuration of the client-side information processing apparatus 11 of the information processing system according to the embodiment.

The information processing apparatus 11 is a terminal apparatus in which a user views a screen and performs operations. The information processing apparatus 11 may be a computer such as a personal computer (PC) or a tablet terminal. The information processing apparatus 11 includes a CPU 111, a ROM 112, an input device 113, a display device 114, a RAM 115, a hard disk 116, a media drive 117, a communication I/F 118, and a system bus 119. The CPU 111, the ROM 112, the input device 113, the display device 114, the RAM 115, the hard disk 116, the media drive 117, and the communication I/F 118 are connected to each other by the system bus 119 so as to be capable of exchanging data with each other.

The CPU 111 controls various devices connected to the system bus 119. The CPU 111 implements various functions and executes various types of processing by reading out computer programs (also called “programs”) stored in the ROM 112, the hard disk 116, or the like, loading the programs into the RAM 115, and executing the programs. Instead of the CPU 111 or in addition to the CPU 111, the information processing apparatus 11 may include another processor such as an MPU, a GPU, an NPU, or a QPU. Additionally, the information processing apparatus 11 may have a plurality of processors of the same type, and each processor may implement different functions. Some or all of the functions of the information processing apparatus 11 may be implemented by one or more circuits, such as an ASIC, a PLD including an FPGA, or the like.

The ROM 112 stores a BIOS program, a boot program, and the like.

The input device 113 performs processing involved in inputting information and the like, accepts information such as instructions from a user or the like, and outputs the information to the CPU 111. The input device 113 may be, for example, a touch panel, a keyboard, a mouse, a robot controller, or the like.

The display device 114 displays computation results from the information processing apparatus 11, display information sent from the virtual server-side information processing apparatus 10, and the like in accordance with instructions from the CPU 111. Note that the display device 114 may be a liquid crystal display device, a projector, an LED indicator, or the like, and any type may be used.

The RAM 115 is used as a main storage device for the CPU 111, and functions as a working area when executing programs.

The hard disk 116 is used for storing and loading application programs, data and libraries necessary for executing the programs, data to be processed by the programs, and the like.

The media drive 117 enables data in the hard disk 116 to be written to a removable storage medium. The media drive 117 makes it possible to move data written into an external digital still camera, a PC, a tablet terminal, or the like.

The communication I/F 118 communicates information with external apparatuses over a network. The communication I/F 118 communicates with the virtual server-side information processing apparatus 10, for example. The communication standard of the communication I/F 118 may be Ethernet, USB, serial communication, wireless communication, or the like, and may use any type of communication.

### Overall Configuration of Information Processing System

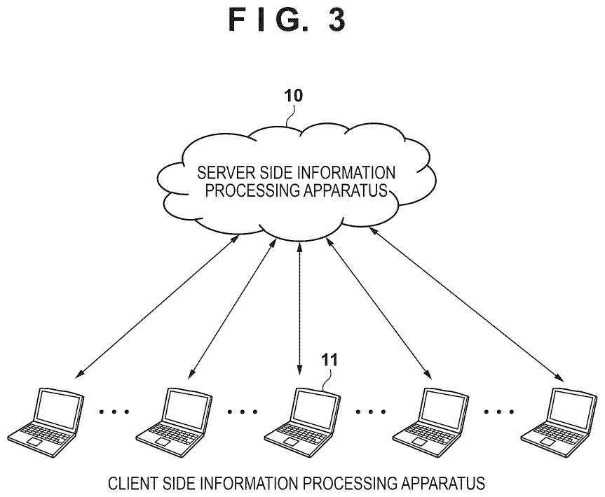

FIG. 3 is a schematic diagram illustrating the overall configuration of the information processing system according to the embodiment. As illustrated in FIG. 3, the information processing system includes the virtual server-side information processing apparatus 10 and one or more client-side information processing apparatuses 11. The virtual server-side information processing apparatus 10 is connected to one or more client-side information processing apparatuses 11 in a communication-enabling manner in order to exchange data therewith. The information processing apparatus 10 controls the exchange of data with the information processing apparatus 11 and the display information displayed in the information processing apparatus 11.

### First Embodiment

The information processing system according to a first embodiment assists a user in the task of selecting a machine learning model. In the information processing system, the virtual server-side information processing apparatus 10 holds a relation degree between machine learning models as a database on a cloud server, and extracts machine learning models related to a machine learning model selected by the user. The client-side information processing apparatus 11 receives information on the related machine learning models, displays the information, and assists the user in the task of selecting the machine learning model.

The present embodiment will describe the machine learning model as performing an object detection task that takes an image as an input as an example of an inference and evaluation task. The object detection task is a task in which image data is input and, if a specific object to be detected appears in the image, a bounding box that surrounds the region thereof is inferred. It is assumed that various tasks aside from object detection tasks are handled, such as tasks for estimating and dividing regions, classification tasks for classifying objects such as people and cars, and the like. For inference and evaluation methods for object detection, methods that use neural networks are known, for example. For object detection learning methods using neural networks, see “Tian et al., ‘FCOS: Fully Convolutional One-Stage Object Detection’, arXiv 2019”.

### Block Diagram Illustrating System Configuration of First Embodiment

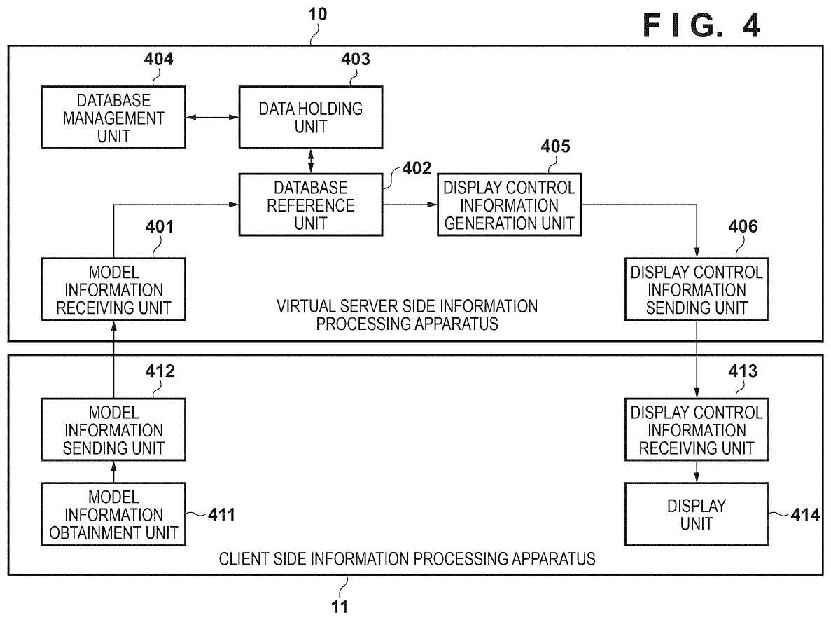

FIG. 4 is a block diagram illustrating an example of the functional configuration of the information processing system according to the first embodiment. The functional configurations of the information processing apparatuses 10 and 11 according to the first embodiment will be described with reference to FIG. 4.

The virtual server-side information processing apparatus 10 includes a model information receiving unit 401, a database reference unit 402, a data holding unit 403, a database management unit 404, a display control information generation unit 405, and a display control information sending unit 406. The processor including the CPU 101 may implement some or all of the functions of the model information receiving unit 401, the database reference unit 402, the data holding unit 403, the database management unit 404, the display control information generation unit 405, and the display control information sending unit 406 by executing programs recorded on the hard disk 105 or the like.

The client-side information processing apparatus 11 includes a model information obtainment unit 411, a model information sending unit 412, a display control information receiving unit 413, and a display unit 414. The processor including the CPU 111 may implement some or all of the functions of the model information obtainment unit 411, the model information sending unit 412, the display control information receiving unit 413, and the display unit 414 by executing programs recorded on the hard disk 116 or the like.

The model information sending unit 412 and the model information receiving unit 401, and the display control information sending unit 406 and the display control information receiving unit 413, may communicate information over a network. FIG. 4 is merely one example of the functional configuration, and is not intended to limit the application scope of the present embodiment.

The model information receiving unit 401 is an example of an obtainment unit that receives and obtains information from the client-side information processing apparatus 11 over a network. The model information receiving unit 401 receives and obtains model information that is information about a machine learning model, for example. The model information may be model information of a machine learning model selected by a user for the purpose of changing a machine learning model. The model information receiving unit 401 may convert the model information into data in a format that is easy to use on the output side. The model information receiving unit 401 outputs the post-data conversion model information to the database reference unit 402.

The database reference unit 402 refers to a database held in the data holding unit 403 and, on the basis of the received model information, refers to a database based on relation information indicating relationships among a plurality of machine learning models. The database reference unit 402 selects, from the database of the obtained relation information among the machine learning models, a machine learning model that is strongly related to the machine learning model selected by the user, as a machine learning model to be recommended to the user. The database reference unit 402 obtains model information of the related machine learning model selected (also called “related model information”) and the like, and outputs that information to the display control information generation unit 405.

The data holding unit 403 holds a database including model information and data of relation information among machine learning models. The data holding unit 403 processes data through the database management unit 404 when using or deleting data in the data holding unit 403 in the virtual server-side information processing apparatus 10.

The database management unit 404 manages a database including the relation information indicating relationships among machine learning models and the like. The database management unit 404 receives information when a new machine learning model is registered in a model storage unit, and updates the model information and the relation information among the models in the database held in the data holding unit 403. For example, the database management unit 404 may manage the database on the basis of a relation degree indicating an extent to which machine learning models are related. The model storage unit may be implemented by the hard disk 105, the ROM 102, the RAM 103, or the like.

The display control information generation unit 405 is an example of a generation unit, and generates display control information for displaying a machine learning model recommended on the client-side information processing apparatus 11 on the basis of the related model information obtained from the database reference unit 402 and the like, as well as the information of the machine learning models included in the database. The display control information generation unit 405 may determine an order of the machine learning models to be displayed on the basis of the relation degree among the machine learning models. The display control information is, for example, information such as a name, model ID, purpose, and performance of the related machine learning model, a display position of that information, and control information related to screen display settings such as a window size. The display control information generation unit 405 outputs the generated display control information to the display control information sending unit 406.

The display control information sending unit 406 receives the display control information and sends that information to the client-side information processing apparatus 11. Note that the display control information sending unit 406 may convert the display control information to an appropriate format before sending, and then send the information.

The model information obtainment unit 411 obtains model information selected by the user for the purpose of changing a machine learning model. The model information is, for example, a model ID for identifying a machine learning model held in the data holding unit 403. When a machine learning model is downloaded, the model information obtainment unit 411 saves the model information in the RAM 115. In the downloading, the machine learning model and the model information are sent and received from the server-side data holding unit 403 via a model sending unit (not shown) and a model receiving unit (not shown). The model ID is information for identifying the machine learning model, and corresponds one-to-one to the machine learning model. The model information obtainment unit 411 may obtain the selected model information displayed in the display device 114 in response to the input device 113, such as a touch panel, a keyboard, a mouse, a robot controller, or the like being operated by the user. The model information obtainment unit 411 outputs the obtained model information to the model information sending unit 412.

The model information sending unit 412 sends the received model information to the model information receiving unit 401. The model information sending unit 412 may convert the model information to an appropriate format before sending, and then send the information.

The display control information receiving unit 413 receives information from a server-side information processing apparatus 10 over a network. The display control information receiving unit 413 receives the display control information from the display control information sending unit 406, for example. The display control information receiving unit 413 converts the received display control information into data in a format that is easy to use on the output side, and outputs the data to the display unit 414.

The display unit 414 displays, on the display device 114, a display screen, for the user, that is based on the display control information received from the display control information receiving unit 413. The display unit 414 performs the display using, for example, a display monitor, a head-mounted display, a touch panel, a projector, or the like. For example, on the basis of the display settings included in the display control information, the display unit 414 displays information such as the name, model ID, purpose, and performance of the related machine learning model in a display position indicated by the display settings of the display device 114.

### Flowchart Illustrating Processing Sequence of Model Information and Related Model Display

A processing sequence of related model recommendation processing according to the present embodiment will be described next. In the following descriptions, an S is added to the beginning of each process (step).

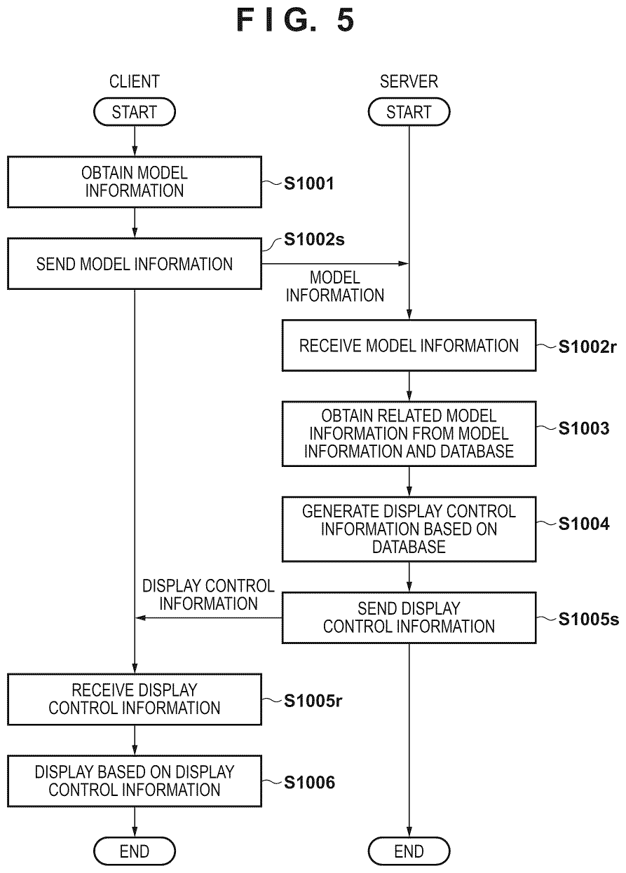

FIG. 5 is a flowchart illustrating the related model recommendation processing for recommending a related machine learning model according to the first embodiment. The related model recommendation processing is illustrated as a flowchart of a processing sequence in which the information processing system including the client-side information processing apparatus 11 and the virtual server-side information processing apparatus 10 display a list of machine learning models related to a machine learning model selected by the user on the basis of the model information. The processing illustrated in the flowchart in FIG. 5 starts when, for example, a machine learning model is selected by the user to be processed. However, the information processing system need not necessarily perform all the steps indicated in this flowchart, and the order of the steps may be changed as appropriate.

In preparation for performing this flowchart, the information processing apparatuses 10 and 11 initialize the system. In other words, the CPU 111 of the client-side information processing apparatus 11 reads out a program from the ROM 112 and puts the client-side information processing apparatus 11 into an operable state. The CPU 101 of the virtual server-side information processing apparatus 10 reads out a program from the ROM 102 and puts the virtual server-side information processing apparatus 10 into an operable state. The client-side information processing apparatus 11 and the virtual server-side information processing apparatus 10 can then communicate with each other using the model information sending unit 412, the model information receiving unit 401, the display control information sending unit 406, and the display control information receiving unit 413.

In step S1001, the model information obtainment unit 411 obtains the model information of a machine learning model selected by the user for the purpose of changing a machine learning model. For example, the user selects a machine learning model for changing from one or more machine learning models displayed in the display device 114 by the display unit 414, and the model information obtainment unit 411 obtains the model information of that machine learning model.

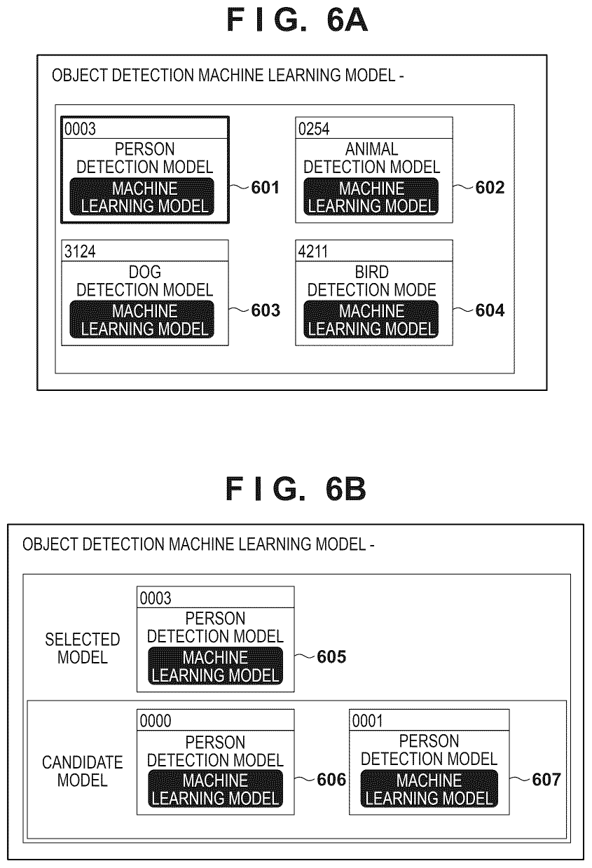

FIGS. 6A and 6B are diagrams illustrating screens displayed when selecting a machine learning model. FIG. 6A is a schematic diagram illustrating a machine learning model selection display screen referred to when the user changes the machine learning model. Machine learning models 601, 602, 603, and 604 displayed in the display screen in FIG. 6A are machine learning models held in the information processing apparatus 11, and are machine learning models that can be selected by the user. The machine learning models 601, 602, 603, and 604 may be machine learning models for detecting different objects, such as people, animals, or the like. The machine learning model 601 surrounded by a bold frame is a machine learning model selected by the user operating the input device 113. The model information obtainment unit 411 obtains the model ID of the machine learning model 601 selected by the user, for example, as the model information. The model ID is information for identifying the machine learning model, and is assumed to be non-overlapping information unique to that model. However, the type of the model information obtained by the model information obtainment unit 411 is not limited to the model ID, and may be any information related to the machine learning model. The model information obtainment unit 411 outputs the obtained model information to the model information sending unit 412.

In step S1002s, the model information sending unit 412 sends the model information received from the model information obtainment unit 411 to the model information receiving unit 401. The model information sending unit 412 may send the obtained model information after converting the data thereof to a format suitable for sending, e.g., by compressing and encrypting the data.

In step S1002r, the model information receiving unit 401 receives the model information and outputs that model information to the database reference unit 402. If the received model information has undergone data conversion, the model information receiving unit 401 may output the received model information to the database reference unit 402 after performing data conversion on the model information, e.g., by decrypting and decompressing the data, to convert the data to its original format.

In step S1003, the database reference unit 402 refers to the database containing the relation information among the models held in the data holding unit 403, and searches for machine learning models related to the machine learning model indicated by the model information received from the model information receiving unit 401. The database reference unit 402 outputs the model information of related machine learning models obtained as a result of the search (also called “related model information”) to the display control information generation unit 405. Note that when many related machine learning models are present, e.g., when the number of machine learning models is greater than a predetermined number, the database reference unit 402 may provide only that number of machine learning models, among machine learning models having a high relation degree, as the search results.

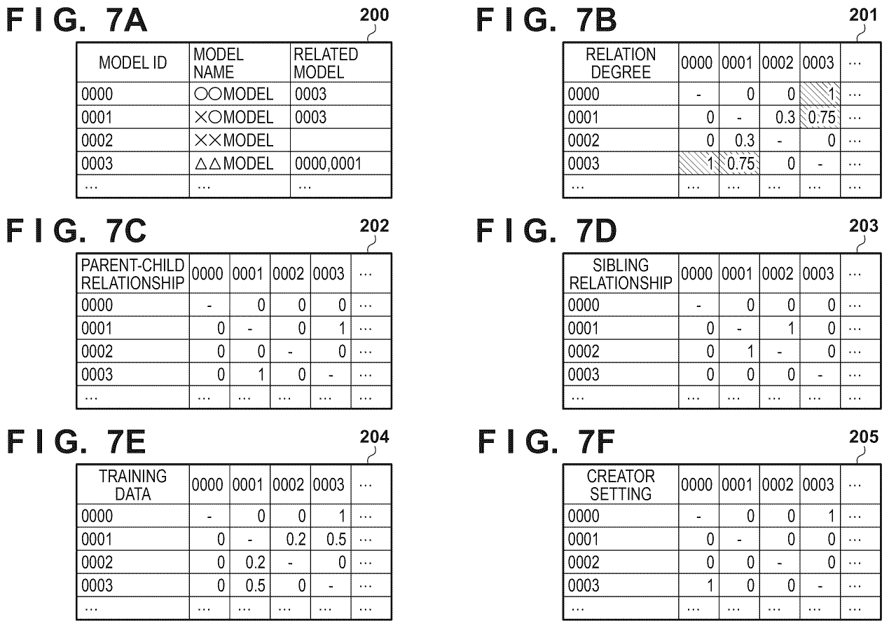

FIGS. 7A to 7F are examples of databases for managing the relation information among machine learning models. The following descriptions will refer to FIGS. 7A to 7F.

FIG. 7A illustrates a database 200 including relation information among machine learning models. The database 200 holds the model ID for identifying the registered machine learning model, a model name associated with the model ID, and the model IDs of related machine learning models. The data holding unit 403 may hold at least the database 200.

FIG. 7B illustrates a database 201 expressing a relation degree among machine learning models. The relation degree is an example of the relation information, and indicates, for example, a degree of relation among the machine learning models. The database 201 is a matrix-form arrangement of relation degrees among machine learning models calculated by the database management unit 404. A machine learning model exceeding a predetermined threshold in the database 201, indicated by hatching, is stored in the database 200 as a related machine learning model. Here, the threshold is set to 0.5, but the threshold may be changed as appropriate.

A database based on a lineage relationship between machine learning models will be described next. Here, “lineage relationship” refers to, for example, a relationship among a plurality of machine learning models having a common initial model from before training was performed, in a case where the machine learning model has been trained repeatedly and updated one or more times.

FIG. 7C illustrates a database 202 based on a parent-child relationship among machine learning models. Here, “parent-child relationship” refers to the relationship between two trained machine learning models when a trained machine learning model is used as the initial model and then subjected to further training. The initial model is the parent, and the model obtained by subjecting the initial model to further training is the child. When there is a parent-child relationship between models, the value of the parent-child relationship is set to 1. However, when there is no parent-child relationship, the value of the parent-child relationship is set to 0. When the parent-child relationship, which is an example of the relation information, is unknown, the value of the parent-child relationship is set to 0. The presence or absence of the parent-child relationship may be obtained from a database indicating relationships between models (not shown). Information about the parent-child relationship may be obtained by storing parent-child relationships in a database (not shown) using the model management unit described in Japanese U.S. Pat. No. 7,281,427 and referring to the model ID. Although 0 or 1 is set here as the value of the parent-child relationship, the relation degree may be set, for example, in accordance with the number of times the machine learning model repeated training. For example, the number of times the machine learning model is trained may be obtained from a model management unit, and the relation degree may be set to be high when the number of repetitions is small.

FIG. 7D illustrates a database 203 based on a sibling relationship among machine learning models. Here, “sibling relationship” refers to a relationship between two models when a trained machine learning model is trained as the initial model, and the initial model is common for the two models. Furthermore, not only can the initial model be a parent, but the relationship between machine learning models that share a common parent of the parent may also be considered a sibling relationship. When there is a sibling relationship between the machine learning models, the value of the sibling relationship, which is an example of the relation information, is set to 1. However, when there is no sibling relationship between the machine learning models, the value of the sibling relationship is set to 0. When the sibling relationship is unknown, the value of the sibling relationship is set to 0. The presence or absence of the sibling relationship may be obtained from a database indicating relationships between models (not shown). Information about the sibling relationship may be obtained by storing sibling relationships in a database (not shown) using a management unit of the model management unit described in Japanese U.S. Pat. No. 7,281,427 and referring to the model ID. Although an example in which the value of the sibling relationship is set to 0 or 1 is described here, the value of the sibling relationship may be set, for example, in accordance with the number of generations between the machine learning models. Specifically, when the number of generations between the machine learning models is small, the value of the sibling relationship may be set high. The number of generations may be, for example, the number of generations traced back to a common machine learning model. In this case, the inverse of the distance between generations of the machine learning model may be used. Specifically, the value of the sibling relationship may be set to ½ if the parents are the same, and the value of the sibling relationship may be set to ¼ if the parents of the parents are the same. The parent-child relationship and the sibling relationship can also be rephrased to say the ancestors of the machine learning model are the same, and in the present embodiment, the relation degree may be set high when the ancestors are the same.

FIG. 7E illustrates a database 204 expressing a ratio at which the same training dataset is used between models, among the training datasets used by each model (also called a “usage ratio” hereinafter). In other words, the database 204 includes, as the relation information, a ratio set in accordance with whether at least some of the training datasets used to train the machine learning models are the same. For example, the usage ratio is set to a value of 0 to 1, where if all of the training datasets are the same, the usage ratio is set to 1; if all of the datasets are different, the usage ratio is set to 0; and if some of the datasets are being used, the usage ratio is set to a value in between. When the usage ratio is unknown, the ratio is set to 0. Information about the usage ratio of the training dataset may be obtained by storing information about the used training dataset in a database (not shown) using a training condition management unit described in Japanese U.S. Pat. No. 7,281,427 and referring to the model ID. The usage ratio of the same dataset may, for example, be calculated as a ratio of the number of common images to all the training images, in the case of images, and may be calculated as a ratio of the number of common lines of data to all the lines of training data, in the case of table data. However, the method for calculating the usage ratio of the dataset is not limited thereto, as long the ratio is expressed.

FIG. 7F illustrates a database 205 expressing a degree of relation among machine learning models and information set by a model creator for each machine learning model. For the purposes of this specification, ‘model creator’ is used interchangeably with ‘model author’ and ‘model developer’. Here, a relationship between machine learning models refers to, for example, a successor model that performs the same task but which lacks at least one of a parent-child relationship and a sibling relationship. For example, the information set by the model creator may be information setting whether a relationship is present among the machine learning models. Various types of machine learning model training methods, initial models for machine learning models, and datasets for training are available. Even if, to improve the performance, a model creator uses an initial model lacking at least one of a parent-child relationship and a sibling relationships to develop a successor model that uses a different training dataset, that model may still be recommended as a related model. When there is a relationship between the machine learning models, the value of the degree is set to 1, and when there is no relationship between the machine learning models, the value of the degree is set to 0. Note that the value of the degree is also referred to as a creator-set flag. Although the present embodiment describes the model creator as being able to freely set the registration of related models, the number of models that can be set may be limited to prevent unrelated models from being registered and displayed indiscriminately. The creator may also pay a fee to set the relationship higher, so that that machine learning model is more likely to be selected. The payment of a fee here is an example of a condition set in advance.

In step S1004, the display control information generation unit 405 generates the display control information necessary for the server-side display unit 414, which is based on the database, to make a display in the display device 114. For example, the display control information generation unit 405 refers to the model information and the database received from the database reference unit 402, obtains the data, and generates the display control information. The display control information generation unit 405 may obtain data such as the model information of machine learning models having a high relation degree, and generate the display control information that sets a display order displaying a pre-set number of machine learning models in order from the highest relation degree. The display control information generation unit 405 may generate the display control information pertaining to display settings such as the display position, the window size, and the display text of each item of model information and the model name associated with that model information. However, the data obtained by the display control information generation unit 405 and the type of the display control information generated are not limited thereto, and may be any information that can be managed in a database. The display control information generation unit 405 outputs the obtained data and the generated display control information to the display control information sending unit 406.

In step S1005s, the display control information sending unit 406 sends the display control information received from the display control information generation unit 405 and the obtained data to the display control information receiving unit 413 on the client side. The display control information sending unit 406 may send the display control information and the obtained data after converting those items to a format suitable for sending, e.g., by compressing and encrypting the data.

In step S1005r, the display control information receiving unit 413 receives the display control information and the obtained data. If converted data is received, the display control information receiving unit 413 may convert the display control information and the obtained data to their original format by decrypting and decompressing the data. The display control information receiving unit 413 outputs the obtained data and the display control information to the display unit 414.

In step S1006, the display unit 414 displays, on the display device 114, a display screen including a list of a plurality of items of model information, on the basis of the obtained data and the display control information received from the display control information receiving unit 413. FIG. 6B is a schematic diagram illustrating a display screen including model information of candidate machine learning models. A machine learning model 605 in the display screen in FIG. 6B is a machine learning model selected by the user. A machine learning model 606 and a machine learning model 607 are candidate models displayed on the basis of the relation degree. For example, if the machine learning model 605 selected by the user is a model that detects a person, other machine learning models 606 and 607 that detect a person are selected and displayed as candidate models.

The information processing system then ends the processing.

As described above, in the present embodiment, a machine learning model related to the machine learning model selected by the user can be selected and presented to the user. Accordingly, in the present embodiment, the ease with which the user selects a machine learning model can be improved.

The present embodiment makes it possible to display a list of recommended models associated with model information.

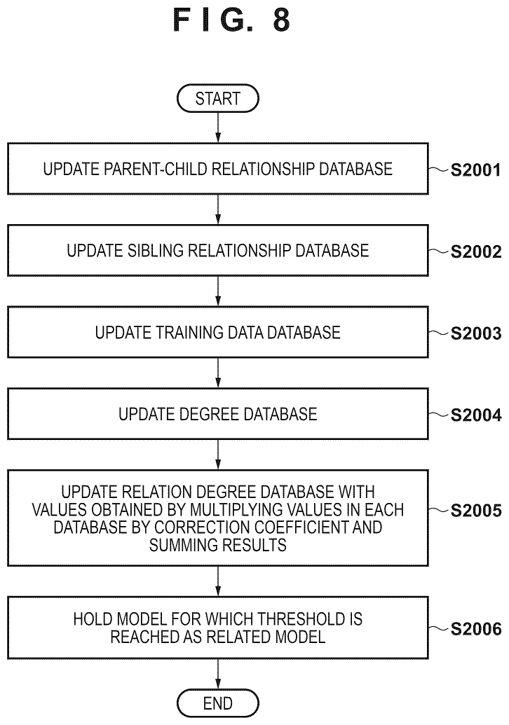

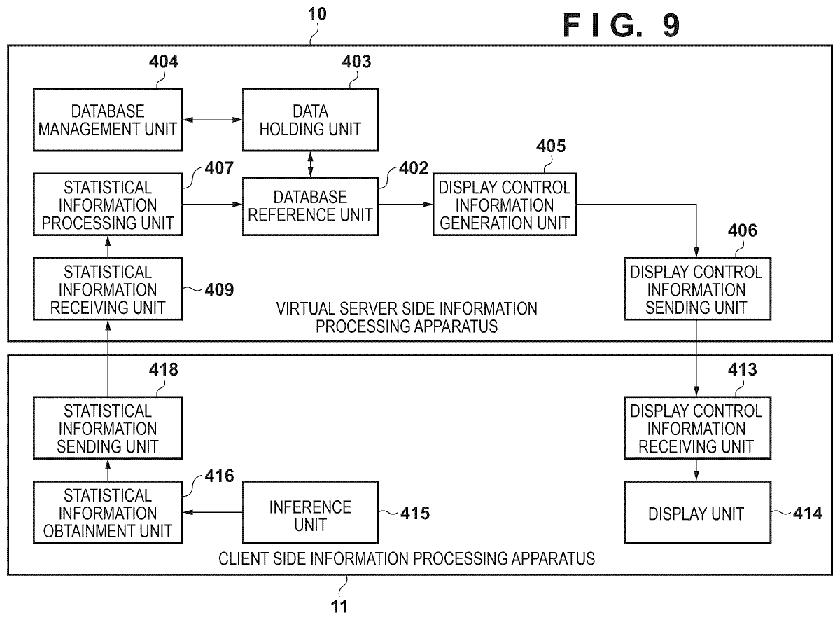

FIG. 8 is a flowchart illustrating related model determination processing for determining a related model according to the first embodiment. In the related model determination processing, the database management unit 404 calculates the relation degree among machine learning models, determines related models, and saves to or updates the database. The database management unit 404 starts the flowchart of FIG. 8 when, for example, a new machine learning model has been added to the model storage unit (not shown).

In step S2001, the database management unit 404 updates the parent-child relationship database 202 in accordance with parent-child relationships among the machine learning models.

In step S2002, the database management unit 404 updates the sibling relationship database 203 in accordance with sibling relationships among the machine learning models.

In step S2003, the database management unit 404 updates the database 204 of training data in accordance with the ratio at which the same training dataset is used among the machine learning models.

In step S2004, the database management unit 404 updates the database 205 of the degrees set by the creator in accordance with the machine learning models related among the models and the information of the creator-set flag indicating the degree set by the model creator.

In step S2005, the database management unit 404 multiplies each database by a correction coefficient, adds the resulting values, and updates the database 201 indicating the relation degree using the sums as the relation degrees. Here, the correction coefficient is a coefficient that corrects which databases between models are prioritized by the server administrator when determining the relation degree. For example, the correction coefficient of the parent-child relationship database 202 is 0.5, the correction coefficient of the sibling relationship database 203 is 0.2, the correction coefficient of the training dataset database 204 is 0.5, and the correction coefficient of the degree database 205 is 1. The database management unit 404 adds the values obtained by multiplying the values in each database by the correction coefficients. For example, the relation degree indicating the relationship between the machine learning model having a model ID of “0001” and the machine learning model having a model ID of “0003” is (0.5)+(0)+(0.25)+(0)=(0.75).

In step S2006, the database management unit 404 refers to the database 201 indicating the relation degree, and compares the corrected relation degree held in the database 201 with a pre-set threshold. Next, the database management unit 404 determines a machine learning model for which the relation degree is at least the threshold to be a related model, and updates the database 200 indicating the relation information among the machine learning models. Here, the threshold is set to 0.5, and the hatched parts of the database are at least the threshold. For example, the machine learning models related to the machine learning model having a model ID of “0003” are the machine learning models having model IDs of “0000” and “0001”. The pre-set threshold may be used by the server administrator to set a recommendation level according to the relation degree. Note that the database management unit 404 may determine a machine learning model for which the relation degree is not greater than the threshold to be a related model.

Through this, the database management unit 404 ends the related model determination processing.

In the present embodiment, a model having a high relation degree is recommended at the timing at which the user selects the machine learning model to be used in the client-side information processing apparatus 11. However, when a new machine learning model related to the virtual server is registered, a display screen may be displayed to recommend that new machine learning model if the new machine learning model is related to the machine learning model being used by the user.

As described above, according to the present embodiment, a machine learning model having a high relation degree to a model currently being used by the user can be selected from among publicized machine learning models and recommended, and thus an information processing system that facilitates the selection of a machine learning model suited to the user's purpose can be provided.

In the present embodiment, the related machine learning model is selected on the basis of a relation degree set in accordance with information such as a lineage relationship, including a parent-child relationship and a sibling relationship, training data, a degree set by the creator, and the like. Through this, the present embodiment makes it possible to more appropriately select a related machine learning model.

### Second Embodiment

In the present embodiment, model information selected on the basis of usage statistic information of the model of a user is used to recommend a machine learning model having a high relation degree with a selected machine learning model.

FIG. 9 is a block diagram illustrating an example of the functional configuration of the information processing system according to the second embodiment. The virtual server-side information processing apparatus 10 includes a statistical information receiving unit 409, the database reference unit 402, the data holding unit 403, the database management unit 404, the display control information generation unit 405, the display control information sending unit 406, and a statistical information processing unit 407. The client-side information processing apparatus 11 includes an inference unit 415, a statistical information obtainment unit 416, a statistical information sending unit 418, the display control information receiving unit 413, and the display unit 414. The second embodiment will primarily describe configurations different from the first embodiment.

The inference unit 415 performs inference in an object detection task performed by the machine learning model in the information processing apparatus 11 on images obtained by an image capturing apparatus (not shown).

The statistical information obtainment unit 416 obtains statistical information on the results of inference from the machine learning model, executed by the inference unit 415. The statistical information obtainment unit 416 may cause the number of non-detections by the machine learning model to be held in the RAM 115 as the statistical information. The statistical information obtainment unit 416 obtains the statistical information from the RAM 115 and outputs the information to the statistical information sending unit 418. The statistical information obtainment unit 416 may output the model information to the statistical information sending unit 418 along with the statistical information.

The statistical information sending unit 418 sends the received statistical information to the statistical information receiving unit 409 of the server-side information processing apparatus 10 along with the model information over a network. Note that the statistical information sending unit 418 may send the statistical information as part of the model information.

The statistical information receiving unit 409 is an example of an obtainment unit, and receives and obtains the statistical information and the model information. The statistical information receiving unit 409 outputs the received statistical information and model information to the statistical information processing unit 407.

The statistical information processing unit 407 determines a machine learning model that is a candidate to be changed on the basis of the statistical information from the inference, obtained from the statistical information receiving unit 409, and outputs the model information to the database reference unit 402.

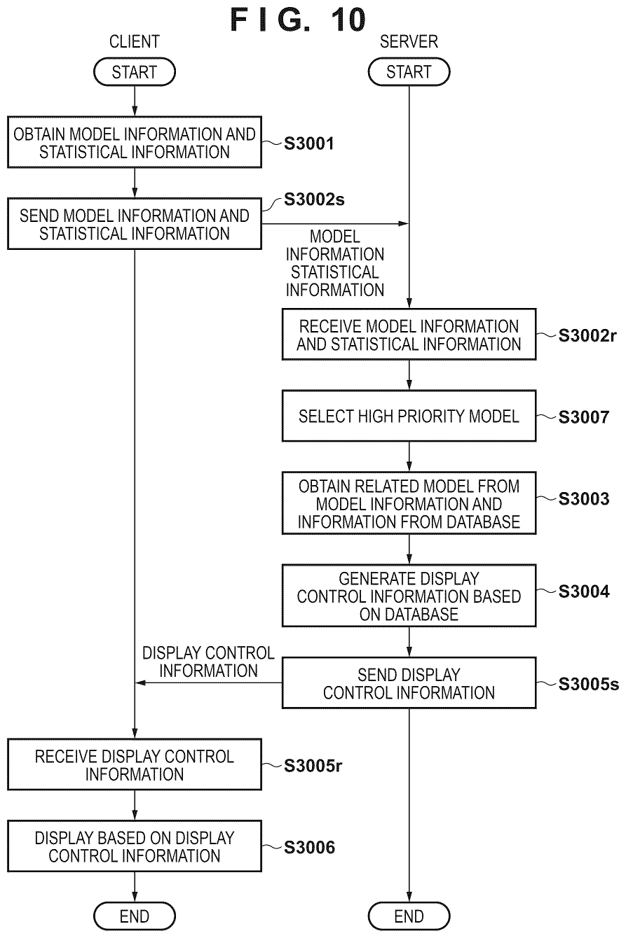

FIG. 10 is a flowchart illustrating the related model recommendation processing for recommending a related machine learning model according to the second embodiment. In the related model recommendation processing of the second embodiment, the information processing system selects a machine learning model from statistical information representing usage tendencies of the user in the second embodiment, and displays a list of related machine learning models. In FIG. 10, reference signs are assigned corresponding to the flowchart of the first embodiment, illustrated in FIG. 5. For example, steps S3002 to S3006 in FIG. 10 are the same processes as steps S1002 to S1006 in FIG. 5, and thus descriptions thereof will be omitted or simplified.

In step S3001, the statistical information obtainment unit 416 obtains, along with the model information, statistical information about at least one of inference and use for the purpose of changing the machine learning model of the user. The statistical information obtainment unit 416 may obtain the number of non-detections by the machine learning model as the statistical information. The number of non-detections by the model is, for example, the number of times the machine learning model did not obtain even one detected region when performing one inference on one input image. The obtained statistical information is subjected to data conversion, e.g., compressed and encrypted by the statistical information obtainment unit 416 into a format suitable for sending. The statistical information obtainment unit 416 then outputs the statistical information to the statistical information sending unit 418 along with the model information.

In steps S3002s and S3002r, the statistical information sending unit 418 on the client side sends the statistical information along with the model information to the statistical information receiving unit 409 on the virtual server side.

In step S3007, the statistical information processing unit 407 selects a machine learning model having a high priority on the basis of the statistical information from the machine learning model of the user. An example will be described here in which, on the basis of a number of non-detections, which is the number of times the detection may have failed, the statistical information processing unit 407 selects a machine learning model having a high number of non-detections as the machine learning model having a high priority, for example. However, the statistical information processing unit 407 may select one of a machine learning model having a high priority based on a number of inference operations (e.g., a machine learning model having a high number of inference operations) or a machine learning model having a high priority based on a number of captures by the image capturing apparatus (e.g., a machine learning model having a high number of captures) as the machine learning model having a high priority. Here, the number of inference operations is a number in which, in an object detection task, the count increases by one for each inference performed on each image input into the machine learning model. If, for example, more highly-related machine learning models than a predetermined number are present, the statistical information processing unit 407 may preferentially select only that number of machine learning models having a high priority. The statistical information processing unit 407 outputs the selected machine learning model having a high priority to the database reference unit 402.

Then, when steps S3003 and S3004 are executed, the database reference unit 402 obtains the related model information from the database on the basis of the model information of the machine learning model having a high priority. The display control information generation unit 405 then generates the display control information in accordance with the machine learning model having a high priority. Note that, on the basis of the database, the display control information generation unit 405 may generate the display control information in accordance with the selected machine learning model having a high priority and a machine learning model having a strong relationship.

In steps S3005s and S3005r, the display control information sending unit 406 on the virtual server side sends the display control information to the display control information receiving unit 413 on the client side.

In step S3006, the display unit 414 displays, on the display device 114, a display screen generated on the basis of the display control information according to the machine learning model having a high priority and the like.

Although the present embodiment describes an example in which the client-side information processing apparatus 11 obtains the statistical information, the same processing can be performed even when the virtual server-side information processing apparatus 10 obtains the statistical information by inference.

As described above, in the present embodiment, statistical information indicating usage tendencies of the user is used to recommend a machine learning model having a high relation degree to a machine learning model that, among the machine learning models currently being used by the user, is a high-priority machine learning model having an issue such as a high number of non-detections for example. As such, according to the present embodiment, an information processing system that makes it possible to easily select a model suited to the user's purpose can be provided.

### Variation on Second Embodiment

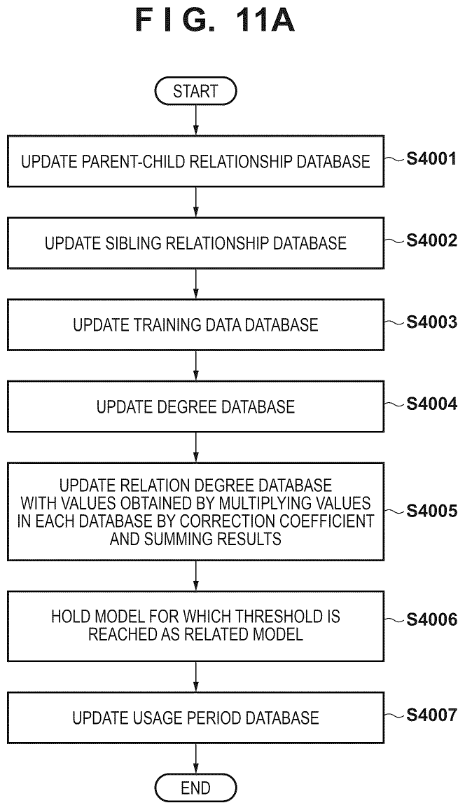

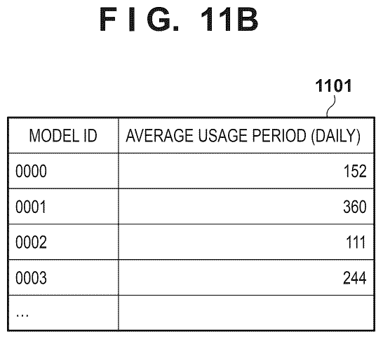

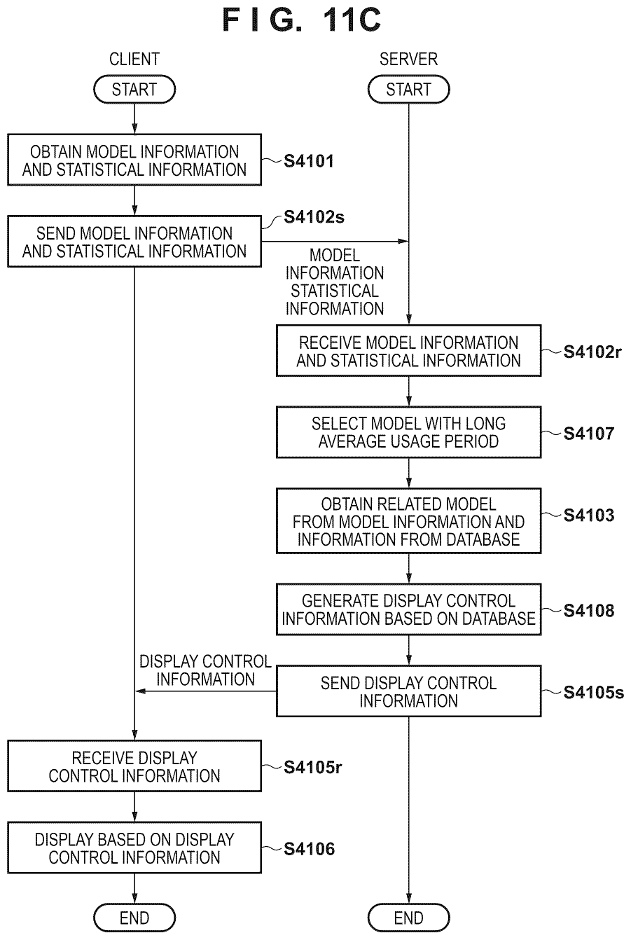

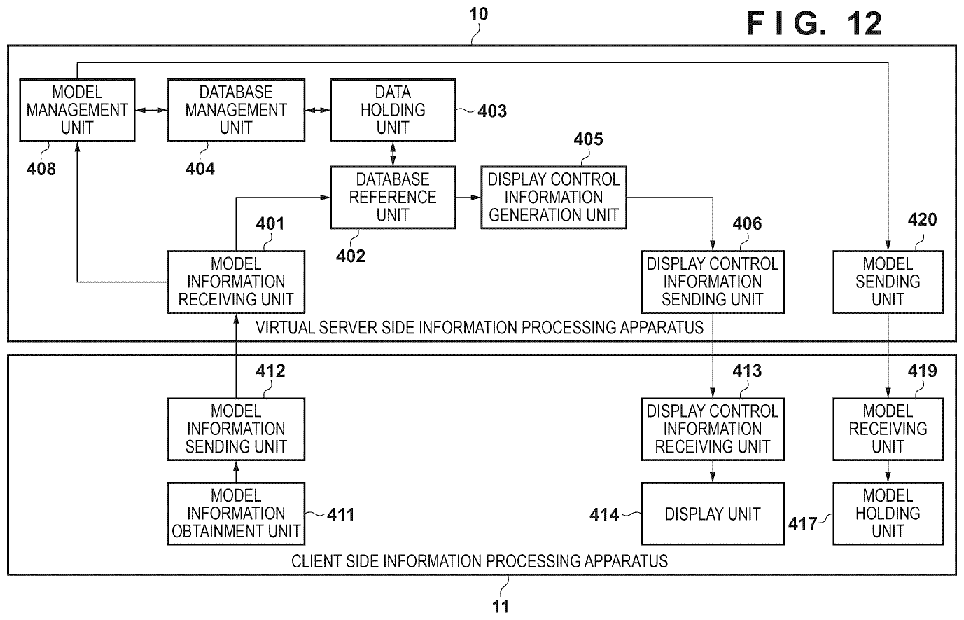

A variation on the second embodiment will describe an example of selecting a machine learning model to be recommended using a usage period of a machine learning model as the statistical information of a user. This example is based on the concept that the accuracy and reliability of a machine learning model tend to be higher the longer the model is used. FIGS. 11A to 11C are diagrams illustrating the variation on the second embodiment.

The statistical information obtainment unit 416 obtains statistical information on the results of inference from the model, executed by the inference unit 415. The statistical information obtainment unit 416 may cause the usage period of the model to be held in the RAM 115 as the statistical information. The statistical information obtainment unit 416 obtains the statistical information from the RAM 115 and sends the information to the model information sending unit 412.

FIG. 11A is a flowchart illustrating related model determination processing for determining a related model according to the variation on the second embodiment. In the related model determination processing, the database management unit 404 calculates the relation degrees among the models and determines the related models. Descriptions of processing that is the same as that described in the foregoing embodiments will be omitted or simplified. For example, steps S4001 to S4006 in FIG. 11A are the same as steps S2001 to S2006 in the first embodiment, and thus descriptions thereof will be omitted or simplified.

In step S4007, on the basis of the usage period of the machine learning model sent from the client-side information processing apparatus 11, the database management unit 404 calculates an average usage period of the machine learning model by the plurality of client-side information processing apparatuses 11, and updates a database pertaining to the usage period of each machine learning model (here, an average usage period database). FIG. 11B illustrates a database 1101 of average usage periods of machine learning models according to the variation on the second embodiment. The average usage period database 1101 associates the model ID of the machine learning model with the average usage period (days). Note that the unit of the average usage period is not limited to days, and may be changed as appropriate. The average usage period of the machine learning model having a model ID of “0001” is the longest, and that machine learning model is treated as a highly reliable machine learning model often used by the user.

Through this, the database management unit 404 ends the related model determination processing.

FIG. 11C is a flowchart illustrating related model recommendation processing for recommending a related machine learning model according to the variation on the second embodiment. In the related model recommendation processing, the information processing system selects a machine learning model from statistical information representing usage tendencies of the user, and displays a list of related machine learning models. In FIG. 11C, reference signs are assigned corresponding to the flowchart of the first embodiment, illustrated in FIG. 10. Descriptions of processing that is the same as that described in the foregoing embodiments will be omitted or simplified. For example, steps S4101 and S4102 are the same processes as steps S3001 and S3002, and steps S4103, S4105, and S4106 are the same processes as steps S3003, S3005, and S3006. Accordingly, descriptions of the same processes will be omitted or simplified.

In step S4107, the database reference unit 402 refers to the database holding the average usage periods, held in the data holding unit 403, and selects a machine learning model having a long average usage period (or usage period). The database reference unit 402 outputs the model information of the selected machine learning model and the like to the display control information generation unit 405.

In step S4108, on the basis of the data, such as the model information, received from the database reference unit 402, the display control information generation unit 405 obtains the data and generates the display control information necessary for display in the display unit 414. For example, the data obtained is data of a machine learning model having a high relation degree, and is data of a machine learning model having a long average usage period. The display control information generation unit 405 may generate the display control information so as to display a pre-set number of machine learning models in order from the highest relation degree. If the number of machine learning models having a high relation degree is at least a predetermined number, the display control information generation unit 405 may select that number of machine learning models having a long average usage period. The display control information generation unit 405 may generate the display control information pertaining to display settings such as the display position, the window size, and the display text of each item of model information and the model name associated with that model information. However, the obtained data and the type of the display control information generated are not limited thereto, and may be any information that can be managed in a database. The display control information generation unit 405 then outputs the obtained data and the generated display control information to the display control information sending unit 406.

Although the present variation describes an example in which the average usage period is used, a median value and a mode value of the usage period may be used to obtain the usage tendencies of the user. Additionally, even if the usage periods are the same, a higher usage frequency by the user is information indicating that the machine learning model is more reliable, and thus a weight may be applied in accordance with the usage frequency when calculating the average.

Furthermore, although the present variation describes using a simple average usage period, the machine learning model that was used immediately before the machine learning model was changed may be held, the average usage periods of the machine learning model used immediately before and the machine learning model after the change may be held in a matrix, and a model having a longer usage period after the change may be recommended.

As described above, according to the present variation, a machine learning model having a high relation degree to the model currently used by the user, and also having a long usage period, such as an average usage period, among publicized machine learning models, can be recommended. Through this recommendation method, the present variation can provide an information processing system that makes it possible to easily select a machine learning model which is often used by users and which is therefore more reliable.

### Third Embodiment

In a third embodiment, a machine learning model having a high relation degree to the downloaded machine learning model is recommended at the timing at which the user downloads the machine learning model from the virtual server-side information processing apparatus 10 to the client-side information processing apparatus 11.

FIG. 12 is a block diagram illustrating an example of the functional configuration of the information processing system according to the third embodiment. The virtual server-side information processing apparatus 10 includes the model information receiving unit 401, the database reference unit 402, the data holding unit 403, the database management unit 404, the display control information generation unit 405, the display control information sending unit 406, a model management unit 408, and a model sending unit 420. The client-side information processing apparatus 11 includes the model information obtainment unit 411, the inference unit 415, the model information sending unit 412, the display control information receiving unit 413, the display unit 414, a model holding unit 417, and a model receiving unit 419.

The model management unit 408 manages machine learning models held in a database or the like of the virtual server-side information processing apparatus 10. The model management unit 408 manages the registration of new machine learning models, the deletion of registered machine learning models, and the like.

The model sending unit 420 receives a machine learning model from the model management unit 408. The model sending unit 420 downloads and sends the received machine learning model to the model receiving unit 419 of the client-side information processing apparatus 11. The display control information sending unit 406 and the model sending unit 420 may be different interfaces, or may be the same interface.

When a newly-registered machine learning model is related to a machine learning model indicated by the model information obtained from the client-side information processing apparatus 11, the display control information generation unit 405 generates display control information that displays the newly-registered machine learning model as a related machine learning model.

The model information receiving unit 401 may receive the model information from the client-side information processing apparatus 11 in accordance with the timing at which the machine learning model is downloaded, or in response to the downloading.

The model receiving unit 419 receives information from the server-side information processing apparatus 10 over a network. The model receiving unit 419 receives information about the machine learning model, for example. The received display control information is output to the display unit 414. The display control information receiving unit 413 and the model receiving unit 419 may be different interfaces, or may be the same interface.

The model holding unit 417 holds models downloaded from among the machine learning models registered in the virtual server-side information processing apparatus 10.

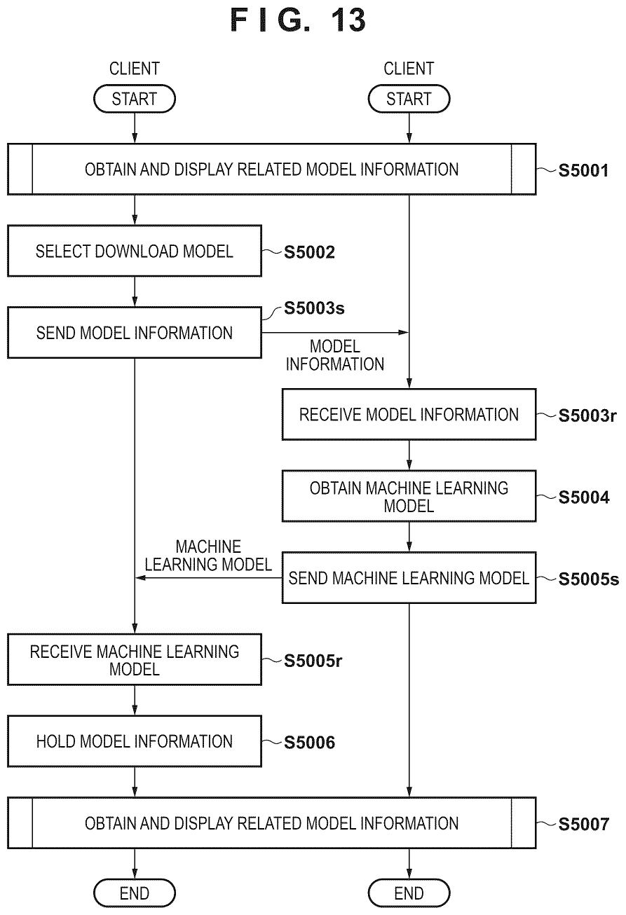

FIG. 13 is a flowchart illustrating the related model recommendation processing for recommending a related machine learning model according to the third embodiment. In the related model recommendation processing according to the third embodiment, a model having a high relation degree to a downloaded machine learning model is recommended at the timing at which a machine learning model selected by the user is downloaded from the virtual server-side information processing apparatus 10 to the

client-side information processing apparatus 10. In step S5001, the display unit 414 displays a list of machine learning models related to the machine learning model selected by the user on the display device 114 as recommended machine learning models. The processing of step S5001 is the same as the processing of steps S1001 to S1006 in the first embodiment.

In step S5002, the model information obtainment unit 411 accepts the selection of a machine learning model to be downloaded from the user. For example, the user may use the input device 113 to select a machine learning model to be downloaded from among the related machine learning models displayed by the display unit 414. The model information obtainment unit 411 outputs information on the machine learning model selected by the user to the model information sending unit 412.

In step S5003s, the model information sending unit 412 sends the model information of the machine learning model selected by the user in step S5002 to the model information receiving unit 401 on the virtual server side. Note that the model information sending unit 412 may send the obtained model information after converting the data thereof to a format suitable for sending, e.g., by compressing and encrypting the data.

In step S5003r, the model information receiving unit 401 receives the model information on the machine learning model selected by the user and outputs the model information to the model management unit 408. If the received model information has undergone data conversion, the model information receiving unit 401 may output the received model information to the model management unit 408 after performing data conversion on the model information, e.g., by decrypting and decompressing the data, to convert the data to its original format.

In step S5004, the model management unit 408 obtains the machine learning model selected by the user and outputs the machine learning model to the model sending unit 420 via the database management unit 404.

In step S5005s, the model sending unit 420 sends the machine learning model selected by a user to the model receiving unit 419 on the client side. The model sending unit 420 may send the machine learning model after converting the data thereof to a format suitable for sending, e.g., by compressing and encrypting the data.

In step S5005r, the model receiving unit 419 on the client side receives the machine learning model and outputs the machine learning model to the model holding unit 417. If the received machine learning model has undergone data conversion, the model receiving unit 419 may output the received machine learning model to the model holding unit 417 after performing data conversion on the machine learning model, e.g., decrypting and decompressing the data, to convert the data to its original format.

In step S5006, the model holding unit 417 holds the model information of a machine learning model newly selected by the user and downloaded. Note that the model holding unit 417 may hold the machine learning model along with the model information.

The processing of step S5007 is also executed. The processing of step S5007 is the same as the processing of steps S1001 to S1006 in the first embodiment. Note that step S5007 may be executed in parallel with other processing. For example, the processing of step S5007 may be executed in parallel at or after step S5002. Here, the display control information sending unit 406 may receive the obtained data of the machine learning model related to the machine learning model selected by the user and the display control information from the display control information generation unit 405, and send those items to the display control information receiving unit 413. In addition, if a newly-registered machine learning model is included in the related machine learning models, the display control information generation unit 405 may generate display control information including the display of the newly-registered machine learning model. The display control information sending unit 406 and the display control information receiving unit 413 may send and receive the data after converting that data. The display control information receiving unit 413 outputs the received display control information to the display unit 414. On the basis of the display control information, the display unit 414 displays, on the display device 114, a screen including information such as machine learning models related to the machine learning model selected by the user.

As described above, in the present embodiment, a model having a high relation degree is recommended at the timing at which a machine learning model is downloaded. This recommendation method makes it possible to provide an information processing system that makes it possible for a user to easily select a model suited to their purpose at the timing at which the user wishes to search for a different machine learning model.

### Fourth Embodiment

In the present embodiment, a user interface (UI) for inputting capture inference failure information is provided, and a machine learning model capable of resolving the failure is recommended by utilizing information on the machine learning model used when capturing an image for which the inference failure information has been input.

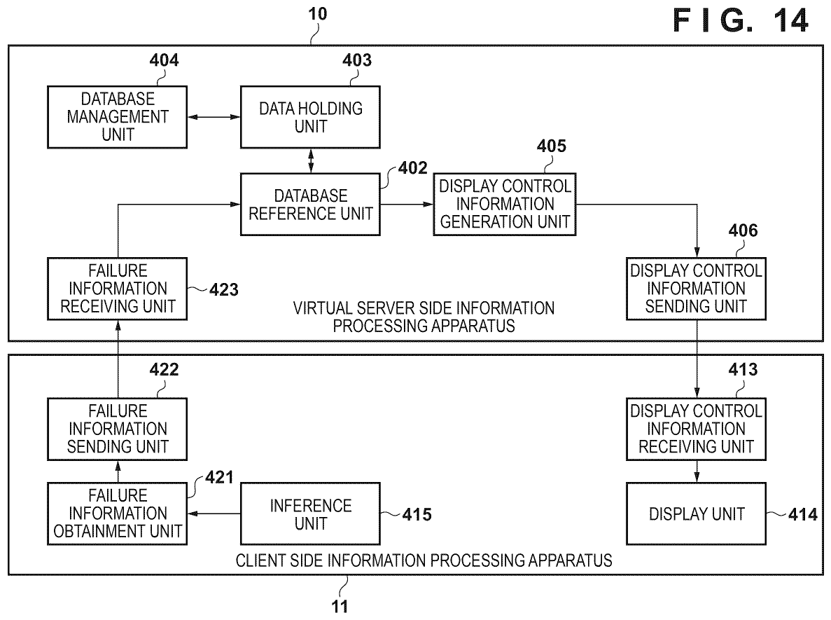

FIG. 14 is a block diagram illustrating an example of the functional configuration of the information processing system according to the fourth embodiment. The fourth embodiment will be described with reference to FIG. 14.

The virtual server-side information processing apparatus 10 includes an inference failure information receiving unit 423, the database reference unit 402, the data holding unit 403, the database management unit 404, the display control information generation unit 405, and the display control information sending unit 406.

The client-side information processing apparatus 11 includes the inference unit 415, an inference failure information obtainment unit 421, an inference failure information sending unit 422, the display control information receiving unit 413, the display unit 414, and the inference unit 415.

The inference unit 415 performs inference using a machine learning model.

The inference failure information obtainment unit 421 generates a display screen for the user to input an image captured by an image capturing apparatus (not shown) and inference failure information obtained when the machine learning model performs inference. The inference failure information obtainment unit 421 obtains the inference failure information input by the user with reference to the input screen and the model information of the machine learning model used in inference on that image. The inference failure information may be flag information indicated as a 0 or a 1, representing the presence or absence of an inference failure, the type and cause of the failure, or the like. Specifically, the inference failure information includes information about the type or cause of the failure, such as a failure due to blurriness, a failure due to focusing on a subject different from the desired subject, or the like. If the user makes an input indicating a failure, the flag for the inference failure information is set to 1, and if not, the flag for the inference failure information is set to 0. In addition, if a flag indicating the type and cause of the failure applies, that flag is set to 1, and if not, the flag is set to 0. Note that all the default values of the inference failure information may be 0. The inference failure information obtainment unit 421 outputs information including the obtained model information and the inference failure information to the inference failure information sending unit 422.

The inference failure information sending unit 422 receives the inference failure information and the model information of the machine learning model used for inference, and sends that information to the inference failure information receiving unit 423 of the server-side information processing apparatus 10.

The inference failure information receiving unit 423 is an example of an obtainment unit, and receives information including the inference failure information and the model information of the machine learning model for which inference has failed from the client-side information processing apparatus 11 over the network. The inference failure information receiving unit 423 outputs the received inference failure information and model information to the database reference unit 402.

When the inference failure information is obtained, the database reference unit 402 refers to a database including at least one of a detection rate (recall) and a false detection rate (described later). The database reference unit 402 obtains related model information about a machine learning model related to the machine learning model selected by the user on the basis of the inference failure information and at least one of the detection rate (recall) and the false detection rate (In the following, ‘false detection rate’ is used as a term synonymous with ‘false positive rate’.).

The database reference unit 402 obtains the related model information from the database on the basis of the inference failure information and the model information.

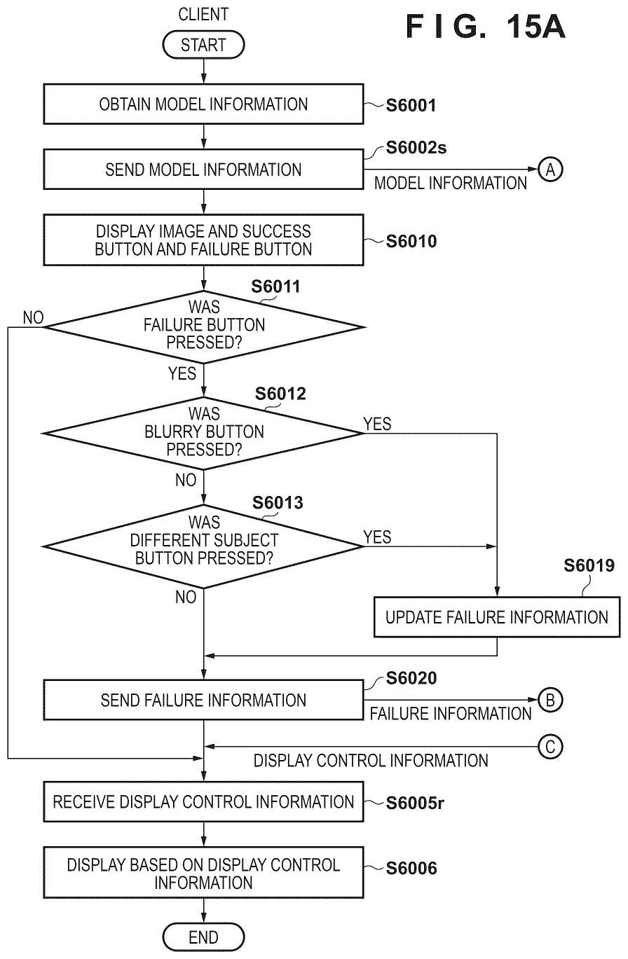

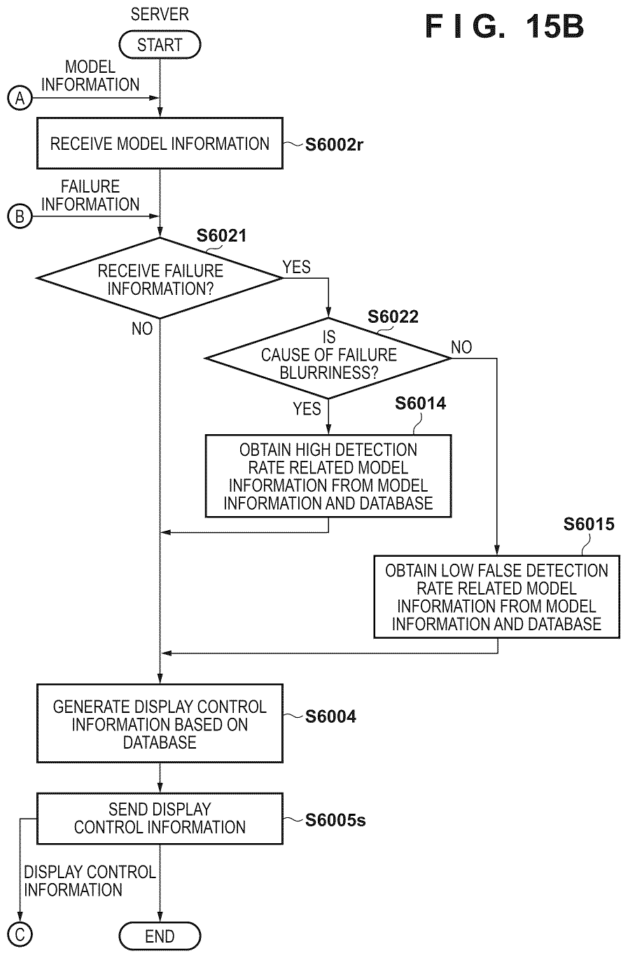

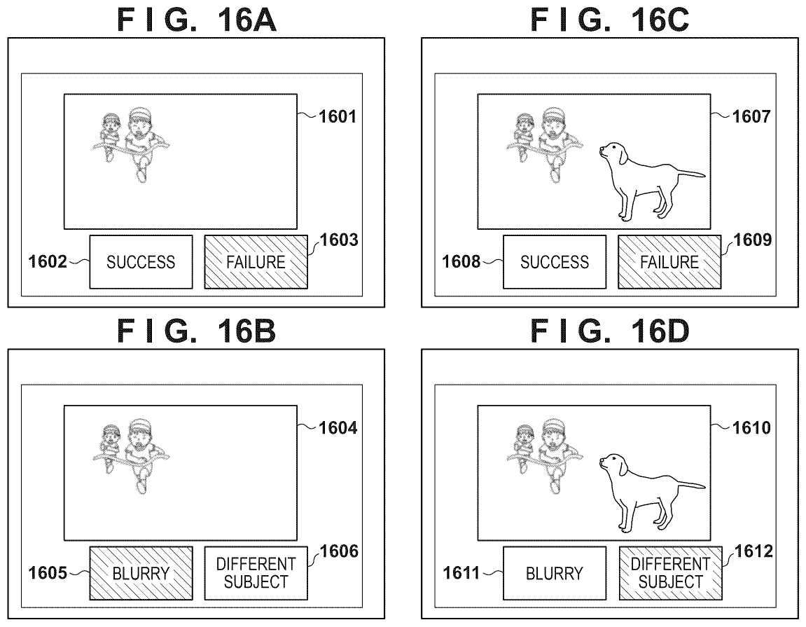

FIGS. 15A and 15B are flowcharts illustrating related model recommendation processing for recommending a related machine learning model according to the fourth embodiment. In the related model recommendation processing according to the fourth embodiment, the user inputs the inference failure information at the timing at which they confirm an image captured by an image capturing apparatus (not shown), and if a failure has occurred, a model having a high relation degree is recommended. FIG. 15A illustrates client-side processing. FIG. 15B illustrates virtual server-side processing. The letters A, B, and C in the circles in FIGS. 15A and 15B indicate connections to each other. FIGS. 16A to 16D are diagrams illustrating an example of screens for inputting inference failure information according to the fourth embodiment.

Descriptions of processing that is the same as that described in the foregoing embodiments will be omitted or simplified. For example, steps S6001 and S6002 are the same processes as steps S1001 and S1002 in the first embodiment, and steps S6004 to S6006 are the same processes as steps S1004 to S1006 in the first embodiment. Accordingly, descriptions of those processes will be omitted or simplified.

In step S6010, the inference failure information obtainment unit 421 causes a screen including a success button and a failure button, along with an image captured by an image capturing apparatus (not shown) and stored in the media drive 117, to be displayed in the display device 114 via the display unit 414. FIGS. 16A to 16D are examples of display screens displayed by the inference failure information obtainment unit 421 for obtaining the inference failure information.

In step S6011, the inference failure information obtainment unit 421 determines whether the failure button has been pressed. FIG. 16A illustrates an example of a display screen displaying an image during image scrolling with the image out of focus. The display screen illustrated in FIG. 16A includes an image 1601, a success button 1602, and a failure button 1603. In the image 1601 in FIG. 16A, if the person who is the subject to be captured is out of focus and a failure has occurred, the user selects and presses the failure button 1603. When the failure button 1603 is pressed, the inference failure information obtainment unit 421 holds “1” as the inference failure information indicating whether a failure has occurred and moves the sequence to step S6012. When the failure button 1603 is not pressed, the inference failure information obtainment unit 421 moves the sequence to step S6005r.

In step S6012, the inference failure information obtainment unit 421 determines whether a “blurry” button 1605 has been pressed. FIG. 16B illustrates an example of a display screen for inputting a cause of failure after the failure button is pressed. The display screen illustrated in FIG. 16B includes an image 1604, the “blurry” button 1605, and a “different subject” button 1606. As illustrated in FIG. 16B, if the person who is the subject to be captured is out of focus and a failure has occurred, the user selects and presses the “blurry” button 1605. One of the reasons for this failure is considered to be that the subject to be captured cannot be detected, i.e., the detection rate (recall) is low.

If the inference failure information obtainment unit 421 determines that the “blurry” button 1605 has been pressed by the user, the sequence moves to step S6019. In step S6019, the inference failure information obtainment unit 421 updates inference failure information caused by blurring to 1, outputs the information to the inference failure information sending unit 422, and moves the sequence to step S6020. On the other hand, if the user does not press the “blurry” button 1605, the inference failure information obtainment unit 421 moves the sequence to step S6013.

In step S6013, the inference failure information obtainment unit 421 determines whether the “different subject” button has been pressed. FIG. 16C illustrates an example of a display screen displaying an image during image scrolling with a different subject in focus. The display screen illustrated in FIG. 16C includes an image 1607, a success button 1608, and a failure button 1609. In the image 1607 in FIG. 16C, the dog, which is a different subject, is in focus, and the person who is the subject to be captured is out of focus, meaning that a failure has occurred. One of the reasons for this failure is considered to be due to the false detection of the subject, i.e., a high false detection rate. In this case, the screen illustrated in FIG. 16D is displayed when the user presses the failure button 1609. FIG. 16D illustrates an example of a display screen for inputting a cause of failure after the failure button 1609 is pressed. The display screen illustrated in FIG. 16D includes an image 1610, a “blurry” button 1611, and a “different subject” button 1612. As illustrated in FIG. 16D, if a subject different from the subject to be captured is falsely detected and the dog, which is the different subject, is in focus, i.e., a failure has occurred, the user selects and presses the “different subject” button 1612.

If the inference failure information obtainment unit 421 determines that the “different subject” button 1612 has been pressed by the user, the sequence moves to step S6019. In step S6019, the inference failure information obtainment unit 421 updates inference failure information caused by a different subject to 1, outputs the information to the inference failure information sending unit 422, and moves the sequence to step S6020. On the other hand, if the user does not press the “different subject” button 1612, the inference failure information obtainment unit 421 moves the sequence to step S6020.

In step S6020, the inference failure information sending unit 422 sends the inference failure information obtained from the inference failure information obtainment unit 421 to the inference failure information receiving unit 423 on the virtual server side. As described above, the inference failure information includes information such as whether a failure has occurred, a failure due to blurriness, a failure due to focusing on a different subject, and the like.

In step S6021, the inference failure information receiving unit 423 on the virtual server side determines whether the inference failure information has been received. If the inference failure information is determined to have been received, the inference failure information receiving unit 423 outputs the inference failure information to the database reference unit 402, and moves the sequence to step S6022. However, if the inference failure information has not been received, the inference failure information receiving unit 423 moves the sequence to step S6004.

In step S6022, the database reference unit 402 refers to the inference failure information obtained from the inference failure information receiving unit 423 and determines the cause of the failure. Specifically, the database reference unit 402 determines whether the cause of the failure is blurriness or focusing on a different subject. If the database reference unit 402 determines that the cause of the failure is blurriness, the sequence moves to step S6014. However, if the database reference unit 402 determines that the cause of the failure is not blurriness, i.e., is that the focus is on a different subject, the sequence moves to step S6015.

In steps S6014 and S6015, the database reference unit 402 obtains related model information of machine learning models from the model information and at least one of the detection rate (recall) and the false detection rate registered in the database, on the basis of at least one of the detection rate (recall) and the false detection rate of the machine learning model selected by the user. The detection rate (recall) and the method for calculating the false detection rate (described later) are described in “Powers, David M W (2011). Evaluation: From Precision, Recall and F-Measure to ROC, Informedness, Markedness & Correlation”.

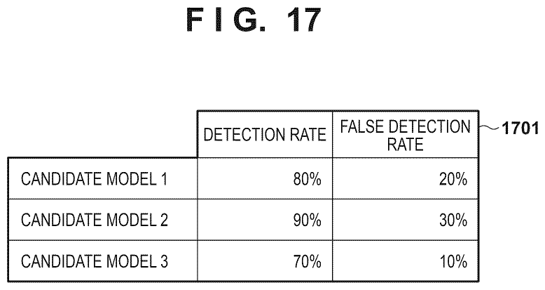

FIG. 17 illustrates a database 1701 of related machine learning models, as well as detection rates and false detection rates, according to the fourth embodiment. The detection rate (recall) may be a value related to, for example, a ratio of the number of times a subject to be detected has been successfully detected relative to the number of inferences made by the machine learning model. The false detection rate may be a value related to, for example, a ratio of the number of times a detection target different from the desired detection target has been erroneously detected, relative to the number of inferences made by the machine learning model.

In step S6014, if the cause of the failure is blurriness, the database reference unit 402 may obtain the related model information of a machine learning model having a high detection rate (recall). This is because if the cause of the failure is blurriness, it is thought that the subject to be captured cannot be detected, i.e., the detection rate (recall) of the machine learning model selected by the user is low. Here, the database reference unit 402 preferentially recommends candidate model 2, which has a high detection rate (recall), on the basis of the database 1701. The database reference unit 402 then moves the sequence to step S6004.

In step S6015, if the cause of the failure is not blurriness, i.e., if a different subject has been detected, the database reference unit 402 obtains related model information having a low false detection rate on the basis of the model information and the database. This is because it is thought that the different subject was detected because the false detection rate of the machine learning model selected by the user is high, and a machine learning model having a low false detection rate should therefore be recommended to the user. The database reference unit 402 preferentially recommends candidate model 3,which has a low false detection rate, on the basis of the database 1701. The database reference unit 402 then moves the sequence to step S6004.

In step S6004, the display control information generation unit 405 generates the display control information based on the database, and outputs that information to the display control information sending unit 406. Note that the display control information generation unit 405 may generate the display control information on the basis of the model information received in step S6002r and the related model information obtained in steps S6014 and S6015.

In steps S6005s, S6005r, and S6006, the display control information sending unit 406 on the virtual server side sends the display control information to the display control information receiving unit 413 on the client side. The display unit 414 displays a display screen on the display device 114 on the basis of the display control information generated according to the inference failure information and the like.

Although the present embodiment recommends a different machine learning model based on the inference failure information of one image, the recommendation may be made on the basis of a plurality of items of input information. The related model may be displayed when the input of the inference failure information has exceeded a predetermined number of items.

As described above, according to the present embodiment, a UI for inputting inference failure information during capture is provided, and a machine learning model capable of resolving the failure and having a high relation degree is recommended on the basis of the inference failure information and the information of the machine learning model used during the capture. Through this recommendation method, the present embodiment can provide an information processing system that makes it possible to easily identify and recommend a machine learning model that solves an issue for the user on the basis of the inference failure information from the user.

In the present embodiment, in addition to whether a failure has occurred, information on the type of the failure is included in the inference failure information. Through this, in the present embodiment, a more appropriate machine learning model can be recommended to the user in accordance with the type of failure.

### Other Embodiments

For example, the information processing system may select a machine learning model to be recommended on the basis of a number of detections in an object detection task. For example, when the number of detections is low, the database reference unit 402 may preferentially recommend a machine learning model having a high detection rate (recall) among related machine learning models. When the number of detections is high, the database reference unit 402 may preferentially recommend a machine learning model having a low false detection rate among related machine learning models.

Although exemplary embodiments have been described in detail above, the present disclosure can also be carried out as an information processing system, an information processing apparatus, an information processing method, a program, a recording medium (a storage medium), and the like. Specifically, the present disclosure may be applied to a system configured of multiple devices (for example, a host computer, an interface device, an image capturing apparatus, a web-based application, or the like) or to an apparatus configured of a single device.

The foregoing embodiments may be combined.

The orders of the steps in each flowchart in the foregoing embodiments may be changed as appropriate.

Although the foregoing embodiments described the virtual server-side information processing apparatus 10 and the client-side information processing apparatus 11 as separate apparatuses, the information processing apparatuses 10 and 11 may be integrated.

Furthermore, it goes without saying that the object of the present disclosure can be achieved as follows. That is, a recording medium (or storage medium) in which is recorded software program code (a computer program) that realizes the functions of the foregoing embodiments is supplied to a system or apparatus. It goes without saying that the storage medium is a computer-readable storage medium. A computer (or CPU, MPU, or the like) in that system or apparatus then reads out and executes the program code stored in the recording medium. In this case, the program code itself read out from the recording medium implements the functions of the foregoing embodiments, and the present disclosure is constituted by the recording medium in which the program code is recorded.

The present disclosure can be implemented by processing of supplying a program for implementing one or more functions of the foregoing embodiments to a system or apparatus over a network or via a storage medium, and causing one or more processors in a computer of the system or apparatus to read out and execute the program. The present disclosure can also be implemented by a circuit (e.g., an ASIC) for implementing one or more functions.

According to the present disclosure, a technique that enables a user to easily select a machine learning model suited to their application can be provided.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No.2024-212424,filed Dec. 5, 2024 which is hereby incorporated by reference herein in its entirety.

What is claimed is:

1. An information processing apparatus comprising:
an obtainment unit configured to obtain model information that is information about a machine learning model;
a reference unit configured to refer to a database indicating relations among a plurality of machine learning models and obtain related model information indicating a machine learning model related to the obtained model information; and
a generation unit configured to, based on the related model information, generate display control information for displaying a screen including information of a recommended machine learning model.

2. The information processing apparatus according to claim 1,
wherein the reference unit refers to the database that is based on relation information pertaining to a degree of model relation among the machine learning models.

3. The information processing apparatus according to claim 1,
wherein the reference unit refers to the database that is based on relation information pertaining to a lineage relationship among the machine learning models.

4. The information processing apparatus according to claim 3,
wherein the reference unit refers to the database that is based on the relation information pertaining to at least one of a parent-child relationship and a sibling relationship among the machine learning models as information about the lineage relationship.

5. The information processing apparatus according to claim 4,
wherein the reference unit refers to the database that is based on the relation information pertaining to a number of repetitions of training in the parent-child relationship.

6. The information processing apparatus according to claim 4,
wherein the reference unit refers to the database that is based on the relation information pertaining to a number of generations between machine learning models in the sibling relationship.

7. The information processing apparatus according to claim 1,
wherein the reference unit refers to the database that is based on relation information pertaining to whether at least a part of training dataset, which the machine learning models used in training, the same or not.

8. The information processing apparatus according to claim 7,
wherein the reference unit refers to the database that is based on the relation information pertaining to a ratio of use of the same training dataset.

9. The information processing apparatus according to claim 1,
wherein the reference unit refers to the database that includes relation information pertaining to information set by creators of the machine learning models.

10. The information processing apparatus according to claim 9,
wherein the reference unit refers to the database that is based on the relation information pertaining to at least one of information set by the creators to indicate whether machine learning models are related and information indicating whether a creator satisfies a predetermined condition.

11. The information processing apparatus according to claim 1,
wherein the obtainment unit obtains model information of a machine learning model selected by a user.

12. The information processing apparatus according to claim 1, further comprising:
a model management unit configured to manage the plurality of machine learning models included in the database,
wherein the obtainment unit obtains the model information in accordance with a timing at which a machine learning model managed by the model management unit is downloaded.

13. The information processing apparatus according to claim 1,
wherein the obtainment unit obtains model information of a machine learning model for which an inference has resulted in failure and inference failure information about the failure, and
the reference unit obtains the related model information pertaining to the inference failure information and the model information.

14. The information processing apparatus according to claim 1, further comprising:
a model management unit configured to manage the plurality of machine learning models included in the database,
wherein in a case where a machine learning model newly registered in the database is a related machine learning model, the generation unit generates the display control information including a display of the registered machine learning model.

15. The information processing apparatus according to claim 1, further comprising:
a statistical information processing unit configured to obtain and process statistical information obtained from inference performed by a machine learning model,
wherein the obtainment unit obtains the statistical information along with the model information.

16. The information processing apparatus according to claim 15,
wherein the statistical information processing unit selects a machine learning model having a high priority based on a number of operations in the inference, and
the reference unit refers to relation information of the machine learning model having the high priority.

17. The information processing apparatus according to claim 15,
wherein the statistical information processing unit selects a machine learning model having a high priority based on a number of non-detections in the inference, and
the reference unit refers to relation information of the machine learning model having the high priority.

18. The information processing apparatus according to claim 1, further comprising:
a database management unit configured to manage the related model information based on a relation degree indicating an extent to which machine learning models are related.

19. The information processing apparatus according to claim 1,
wherein the generation unit determines a display order of information of the machine learning model related, based on a relation degree indicating an extent of relation.

20. The information processing apparatus according to claim 1,
wherein the reference unit obtains the related model information by referring to the database based on at least one of a detection rate and a false detection rate, the detection rate being a ratio of a number of times a target object was detected to a number of times a machine learning model performed inference, and the false detection rate being a ratio of a number of times a false detection was made to a number of times a machine learning model performed inference.

21. The information processing apparatus according to claim 20,
wherein in a case where the detection rate of the obtained machine learning model is low, the reference unit obtains the related model information of a machine learning model having a high detection rate among one or more related machine learning models.

22. The information processing apparatus according to claim 20,
wherein in a case where the false detection rate of the obtained machine learning model is high, the reference unit obtains the related model information of a machine learning model having a low false detection rate among one or more related machine learning models.

23. The information processing apparatus according to claim 20,
wherein in a case where inference failure information regarding inference failure indicates that a subject to be captured was not detected, the reference unit obtains the related model information of a related machine learning model from the database based on the detection rate.

24. The information processing apparatus according to claim 20,
wherein in a case where inference failure information regarding inference failure indicates that a different subject was detected, the reference unit obtains the related model information of a related machine learning model from the database based on the detection rate and the false detection rate.

25. The information processing apparatus according to claim 1,
wherein the reference unit refers to the database that includes a usage period of the machine learning models, and obtains the related model information of a related machine learning model, and
the generation unit generates the display control information based on the usage period.

26. An information processing method comprising:
obtaining model information that is information about a machine learning model;
referring to a database indicating relations among a plurality of machine learning models and obtain related model information indicating a machine learning model related to the obtained model information; and
generating, based on the related model information, display control information for displaying a screen including information of a recommended machine learning model.

27. A non-transitory computer-readable storage medium storing a computer program that, when read and executed by a computer, causes the computer to:
obtain model information that is information about a machine learning model;
refer to a database indicating relations among a plurality of machine learning models and obtain related model information indicating a machine learning model related to the obtained model information; and
generate, based on the related model information, display control information for displaying a screen including information of a recommended machine learning model.
